(19) United States
(12) Patent Application Publication
(10) Pub. No.: US 2020/0278424 A1
(43) Pub. Date: Sep. 3, 2020

(54) DISTANCE MEASURING SENSOR

(71) Applicant: MOSTOP CO., LTD., Hwaseong-si, Gyeonggi-do (KR)

(72) Inventors: Seung Soo LEE, Anyang-si, Gyeonggi-do (KR); Yi Hyun NAM, Uiwang-si, Gyeonggi-do (KR); Kyung Eui HONG, Suwon-si, Gyeonggi-do (KR); Won Kyu LIM, Seoul (KR)

(21) Appl. No.: 16/645,972

(22) PCT Filed: Sep. 28, 2018
(86) PCT No.: PCT/KR2018/011495

§ 371 Date: Mar. 10, 2020

(30) Foreign Application Priority Data
Sep. 28, 2017 (KR) 10-2017-0126627
Aug. 14, 2018 (KR) 10-2018-0095106

(51) Int. Cl. G01S 7/481; G02B 3/02

(52) U.S. Cl. CPC G01S 7/4811; G02B 3/02

(57) ABSTRACT

An embodiment of the present invention may provide a distance measurement sensor including: a housing including a first hollow unit formed to be opened toward a top at one end, and a second hollow unit formed to be opened toward the top at the other end; a sensor package disposed in the housing and located under the first hollow unit; a light guide disposed in the housing and located between the second hollow unit and the sensor package to transfer light entering the second hollow unit to the sensor package; and a lens unit located in at least one among the first hollow unit and the second hollow unit.

### TECHNICAL FIELD

The present invention relates to a distance measurement sensor, and more specifically, to a distance measurement sensor with improved light emitting efficiency and light receiving efficiency.

### BACKGROUND ART

A sensor which measures distance using light may be generally implemented by selecting one among a triangulation method and a method of calculating a return time of reflected light (TOF measurement method).

A sensor using the TOF measurement method may include a light emitting unit (a device for providing light) and a light receiving unit (a device for receiving light). A time of light taken for being emitted from the light emitting unit, being radiated to and reflected by an object, and reaching the light receiving unit may be calculated. The distance measurement sensor using the TOF measurement method can be miniaturized and applied to various electronic devices.

However, in the case of the distance measurement sensor using the TOF measurement method, the risk of error related to distance measurement can be very high due to the neighboring arrangement of the light emitting unit and the light receiving unit. If the probability of light, radiated from the light emitting unit, of being reflected by the object and entering again the light emitting unit is lowered, the error related to the distance measurement can be significantly reduced.

### DISCLOSURE OF INVENTION

### Technical Problem

Therefore, the present invention has been made in view of the above problems, and it is an object of the present invention to provide a distance measurement sensor provided with a light emitting lens which forms unaligned multiple optical axes.

Another object of the present invention is to provide a distance measurement sensor provided with a light guide for collecting incident light and transferring the collected light to a light receiving unit.

The technical problems to be solved by the present invention are not limited to the technical problems mentioned above, and unmentioned other technical problems may be clearly understood by those skilled in the art from the following descriptions.

### Technical Solution

To accomplish the above objects, according to one aspect of the present invention, there is provided a distance measurement sensor comprising: a housing including a first hollow unit formed to be opened toward the top at one end, and a second hollow unit formed to be opened toward the top at the other end; a sensor package disposed in the housing and located under the first hollow unit; a light guide disposed in the housing and located between the second hollow unit and the sensor package to transfer light entering the second hollow unit to the sensor package; and a lens unit located in at least one among the first hollow unit and the second hollow unit, in which the sensor package includes: a light emitting unit for providing light toward the first hollow unit; and a light receiving unit spaced apart from the light emitting unit and located between the light emitting unit and the second hollow unit to receive light from the light guide, and the lens unit includes at least one among a light emitting lens located in the first hollow unit above the light emitting unit to slantingly face the light emitting unit, and a light receiving lens located in the second hollow unit above the light guide to slantingly face the top of the housing.

### Advantageous Effects

A distance measurement sensor according to an embodiment of the present invention may be provided with a light emitting lens which forms unaligned multiple optical axes.

A distance measurement sensor according to an embodiment of the present invention may be provided with a light guide for collecting incident light and transferring the collected light to a light receiving unit.

The effects of the present invention are not limited to the effects mentioned above, and it should be understood that all the effects that can be inferred from the configuration of the present invention disclosed in the detailed description or the claims of the present invention are included.

### BRIEF DESCRIPTION OF THE DRAWINGS

FIGS. 1 and 2 are views showing a distance measurement sensor according to an embodiment of the present invention.

FIGS. 3 to 6 are views showing several embodiments of a light emitting lens and a sensor package of a distance measurement sensor according to an embodiment of the present invention.

FIGS. 7 to 9 are views showing various embodiments of a light emitting lens.

FIGS. 10 and 11 are views showing a distance measurement sensor according to another embodiment of the present invention.

FIG. 12 is a view showing a light guide seen from the top according to an embodiment of the present invention; and

FIGS. 13 to 16 are views showing diverse combinations of a light receiving lens and a light guide of the present invention.

FIG. 17 is a view showing the cross-section of light traveling inside the light guide shown in FIG. 16.

### BEST MODE FOR CARRYING OUT THE INVENTION

Hereinafter, the present invention will be described with reference to the accompanying drawings. However, the present invention may be implemented in various different forms and accordingly is not limited to the embodiments described here. In addition, the parts unrelated to the description are omitted from drawings to clearly describe the present invention, and like elements are denoted by like reference numerals throughout the specification.

Throughout the specification, when an element is “connected to (link to, in contact with, coupled to)” another element, it includes a case of “indirectly connecting” the elements with intervention of another element therebetween, as well as a case of “directly connecting” the elements. In addition, when an element “includes” a constitutional element, it means further including another constitutional element, not excluding another constitutional element, as far as an opposed description is not specially specified.

The terms used herein are only to describe particular embodiments, not intended to limit the present invention. Singular expressions are intended to include plural expressions as well, unless the context clearly indicates otherwise. It should be understood that the terms “include”, “have” and the like used herein are to specify presence of features, integers, steps, operations, elements, components or a combination of these stated in the specification, but do not preclude the possibility of presence or addition of one or more other features, integers, steps, operations, elements, components, or combinations of these.

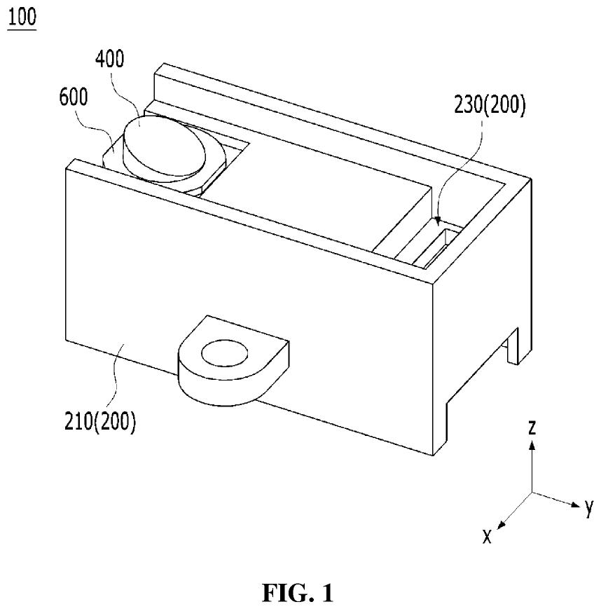

Referring to FIG. 1, a distance measurement sensor 100 according to an embodiment of the present invention is observed. The distance measurement sensor 100 may include a housing 200. The housing 200 may include a housing body 210. The housing body 210 may form a skeleton of the distance measurement sensor 100. The housing body 210 may have a shape elongated in one direction. For example, the housing body 210 may have a shape elongated in the Y-axis direction. The length direction of the housing body 210 may be parallel to the Y-axis direction.

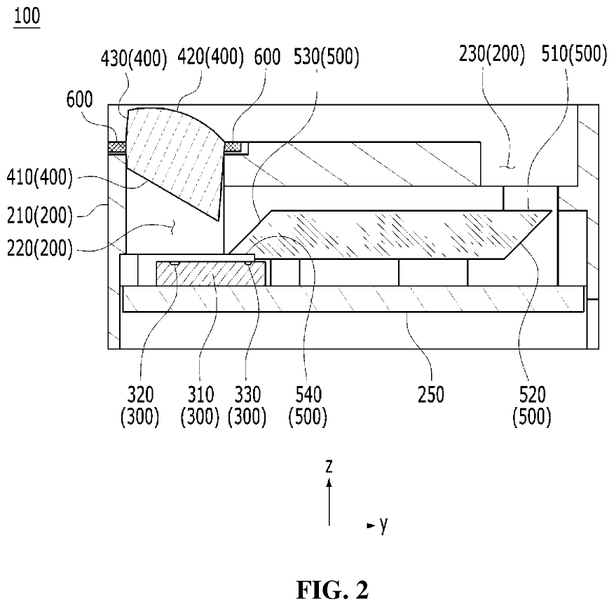

The housing body 210 may form a space for accommodating the parts of the distance measurement sensor 100. For example, a first hollow unit 220 (see FIG. 2) may be formed at an end of the housing body 210.

The distance measurement sensor 100 may include a light emitting lens 400 and a coupling plate 600. The light emitting lens 400 and the coupling plate 600 may be located at an end of the housing body 210. The light emitting lens 400 may be accommodated in the first hollow unit 220 (see FIG. 2) of the housing body 210. The coupling plate 600 may be coupled to the light emitting lens 400. The coupling plate 600 may support the light emitting lens 400. The coupling plate 600 may be seated on the housing body 210. The light emitting lens 400 may be referred to as a “first lens”. The light emitting lens 400 may be referred to as a “light emitting lens”.

A second hollow unit 230 may be formed at the other end of the housing body 210. A light emitting element located inside the housing body 210 may provide light to the light emitting lens 400. Light passing through the light emitting lens 400 may reach and be reflected by a measurement object. The light reflected by the measurement object may enter inside the housing body 210 through the second hollow unit 230. Measurement of distance (or position) to the measurement object may be performed by analyzing the emitted light and the reflected light. For example, the distance to the measurement object may be measured by calculating a time of light emitted from the distance measurement sensor 100, which is taken to enter and be reflected by the measurement object and reach the distance measurement sensor 100. The distance measurement sensor 100 may measure the distance to the measurement object by using a time of flight (TOF) method.

The distance measurement sensor 100 may be installed and used in a device and/or a facility. For example, the distance measurement sensor 100 may be installed in a robot cleaner, a process facility, a car, a gate, or the like. The housing body 210 may form a portion protruding toward one side. For example, the housing body 210 may form a protrusion protruding in the X-axis direction. The protrusions formed in the housing body 210 may facilitate the distance measurement sensor 100 to be installed in a device and/or a facility.

FIG. 2 is a cross-sectional view of the distance measurement sensor 100 of FIG. 1 cut in the longitudinal direction (length direction). Referring to FIG. 2, the housing body 210 may have a shape elongated from one end toward the other end. The first hollow unit 220 may be formed at one end of the housing body 210. The second hollow unit 230 may be formed at the other end of the housing body 210. The first hollow unit 220 and the second hollow unit 230 may be located opposite to each other in the housing body 210. The first hollow unit 220 and the second hollow unit 230 may be opened toward the top.

The distance measurement sensor 100 may include a substrate 250. The substrate 250 may be installed in the housing body 210. The substrate 250 may be connected to an external power source. The substrate 250 may communicate with an external device. For example, the substrate 250 may include a communication module. The substrate 250 may be electrically connected to the external device. For example, the substrate 250 may include a port connected to the external device. The substrate 250 may include a micro controller unit (MCU) for controlling various signals. For example, the MCU may control the strength (or intensity) and cycle of the light emitted from the light emitting unit 320.

The distance measurement sensor 100 may include a sensor package 300. The sensor package 300 may be electrically connected to the substrate 250. The sensor package 300 may be mounted on the substrate 250. The sensor package 300 may be located to be adjacent to one end of the housing body 210. For example, a portion of the sensor package 300 may be located in the first hollow unit 220 of the housing body 210.

The sensor package 300 may include a base 310, a light emitting unit 320, and a light receiving unit 330. The light emitting unit 320 and the light receiving unit 330 may be mounted on the base 310. The light emitting unit 320 may include, for example, a laser diode or an infrared diode. The sensor package 300 may be mounted on the substrate 250 through SMT or wire bonding.

The light emitting unit 320 may be located under the first hollow unit 220. The light emitting unit 320 may provide light toward the top of the first hollow unit 220.

The light receiving unit 330 may be spaced apart from the light emitting unit 320. The light receiving unit 330 may be closer to the second hollow unit 230 than the light emitting unit 320. The light receiving unit 330 and the light emitting unit 320 may be disposed in the length direction (Y-axis direction) of the housing body 210. The light receiving unit 330 may be located between the light emitting unit 320 and the second hollow unit 230.

The light emitting lens 400 may be accommodated in the first hollow unit 220. The light emitting lens 400 may include an exterior surface. For example, the light emitting lens 400 may include a first lens surface 410, a second lens surface 420, and a body surface 430. The first lens surface 410 may be referred to as an “incident surface”. The second lens surface 420 may be referred to as an “emission surface”. The body surface 430 may be referred to as a “lateral surface”.

The light emitting lens 400 may include a medium in which incident light may travel. For example, the light emitting lens 400 may include glass. The refractive index of the light emitting lens 400 including glass may be about 1.45 at room temperature. For example, the refractive index of the light emitting lens 400 may be 1.517 for light having a wavelength of 589.29 nm.

For example, the light emitting lens 400 may include polycarbonate (PC). The refractive index of the light emitting lens 400 using the PC as a material may be 1.584 for light having a wavelength of 587.6 nm. For example, the light emitting lens 400 may include polymethylmethacrylate (PMMA). The refractive index of the light emitting lens 400 including the PMMA may be about 1.5 at room temperature. For example, the refractive index of the light emitting lens 400 may be 1.502 for light having a wavelength of 436 nm. For example, the refractive index of the light emitting lens 400 may be 1.492 for light having a wavelength of 589 nm.

When the light emitting lens 400 includes PC and/or PMMA, manufacturing of the light emitting lens 400 may be easy. When the light emitting lens 400 includes PC and/or PMMA, miniaturization of the light emitting lens 400 may be easy.

The first lens surface 410 may face the light emitting unit 320. For example, the first lens surface 410 may slantingly face the light emitting unit 320. The light generated from the light emitting unit 320 may slantingly enter the first lens surface 410.

The second lens surface 420 may be located on the opposite side of the first lens surface 410. The second lens surface 420 may be spaced apart from the first lens surface 410. The second lens surface 420 may face the exterior of the housing body 210. The second lens surface 420 may form a curvature. The light passing through the first lens surface 410 may pass through the second lens surface 420 and proceed toward the outside.

The body surface 430 may be elongated from the first lens surface 410 and meet the second lens surface 420. The body surface 430 may form a lateral surface of the light emitting lens 400. The body surface 430 may have a partial shape of the lateral surface of a cylinder. The body surface 430 may be coupled to the coupling plate 600. Alternatively, the coupling plate 600 may be integrally formed on the body surface 430 of the light emitting lens 400.

The coupling plate 600 may be coupled to the light emitting lens 400. The coupling plate 600 may have rigidity. The coupling plate 600 may have a shape of a plate. For example, the coupling plate 600 may have an opening. The light emitting lens 400 may be inserted in and coupled to the opening formed in the coupling plate 600. The coupling plate 600 may be seated on the housing body 210.

The distance measurement sensor 100 may include a light guide 500. The light guide 500 may be located in the housing body 210. The light guide 500 may have a shape elongated from the first hollow unit 220 toward the second hollow unit 230. The length direction of the light guide 500 may be parallel to the length direction of the housing body 210.

A portion of the light guide 500 may be located in the second hollow unit 230. The light guide 500 may be disposed between the sensor package 300 and the second hollow unit 230. For example, the light guide 500 may be disposed between the light receiving unit 330 and the second hollow unit 230.

The light guide 500 may form an exterior surface. For example, the light guide 500 may include a first guide surface 510, a second guide surface 520, a third guide surface 530, and a fourth guide surface 540.

The light guide 500 may include a medium in which incident light may travel. For example, the light guide 500 may include quartz or PMMA. The characteristics related to the medium of the light guide 500 may be similar to the characteristics related to the medium of the light emitting lens 400.

The first guide surface 510 may be referred to as an “incident surface”. At least a portion of the first guide surface 510 may be located in the second hollow unit 220. At least a portion of the first guide surface 510 may face the top of the second hollow unit 220. The first guide surface 510 may be referred to as a “top surface”.

The second guide surface 520 may be bent downward from the first guide surface 510 and elongated toward the first hollow unit 220. The second guide surface 520 may be located in the second hollow unit 230. The second guide surface 520 may form a slope with the first guide surface 510. For example, an angle formed by the second guide surface 520 and the first guide surface 510 may be related to a critical angle. The critical angle may be related to total internal reflection of light traveling from the first guide surface 510 toward the second guide surface 520. The second guide surface 520 may form a curved surface.

The third guide surface 530 may be located on the opposite side of the second guide surface 520. The direction that the third guide surface 530 faces may be substantially opposite to the direction that the second guide surface 520 faces. The third guide surface 530 may be located at an end of the light guide 500. On the contrary, the second guide surface 520 may be located at the other end of the light guide 500. Light reaching the second guide surface 520 may travel toward the third guide surface 530. The light traveling from the second guide surface 520 toward the third guide surface 530 may travel in the length direction of the light guide 500.

The light traveling from the second guide surface 520 toward the third guide surface 530 may be collected while traveling toward the third guide surface 530. For example, when at least a portion of the second guide surface 520 forms a curved surface, the second guide surface 520 may perform a function of a lens collecting light. The curved surface formed on the second guide surface 520 may be convex, for example, toward the outside of the second guide surface 520.

The third guide surface 530 may form a slope with respect to the direction toward the second guide surface 520. The third guide surface 530 may form a slope with respect to the first guide surface 510. An angle formed by the third guide surface 530 with respect to the first guide surface 510 may be related to total internal reflection of light traveling from the second guide surface 520 toward the third guide surface 530.

The fourth guide surface 540 may be bent downward from the third guide surface 530 and elongated toward the second hollow unit 230. The fourth guide surface 540 may be located on the opposite side of the first guide surface 510. The fourth guide surface 540 may form the bottom surface of the light guide 500. The fourth guide surface 540 may be referred to as a “bottom surface”. The fourth guide surface 540 may be located on the top of the light receiving unit 330. The fourth guide surface 540 may face the light receiving unit 330.

The light totally internally reflected by the third guide surface 530 may travel toward the fourth guide surface 540. The light traveling from the third guide surface 530 toward the fourth guide surface 540 may be collected while traveling toward the fourth guide surface 540. For example, when at least a portion of the third guide surface 530 forms a curved surface, the third guide surface 530 may perform a function of a lens collecting light. For example, the curved surface formed on the third guide surface 530 may be convex toward the outside. For example, the shape of the third guide surface 530 may correspond to a partial shape of a cylinder.

A measurement object may be positioned on the top of the distance measurement sensor 100. Part of the light emitted from the light emitting unit 320 may reach the measurement target by way of the first lens surface 410 and the second lens surface 420. Part of the light reaching the measurement object may be reflected from the measurement object and enter the second hollow unit 230. The light passing through the second hollow unit 230 may enter the first guide surface 510.

The second hollow unit 230 may be located below the top of the housing body 210. That is, the top side of the housing body 210 adjacent to the second hollow unit 230 may be formed to be further elongated upward from the second hollow unit 230. Accordingly, the light reflected from the measurement object and entering the second hollow unit 230 may be less affected by disturbance light.

The light entering the first guide surface 510 may travel inside the light guide 500 and reach the second guide surface 520. The light reaching the second guide surface 520 may travel toward the third guide surface 530 by total internal reflection of the second guide surface 520. The light reaching the third guide surface 530 may travel toward the fourth guide surface 540 by the total internal reflection. The light reaching the fourth guide surface 540 may travel toward the outside of the light guide 500 and reach the light receiving unit 330.

Remaining part of the light reaching the measurement object may be reflected from the measurement object and reach again the second lens surface 420 of the light emitting lens 400. When the light entering the second lens surface 420 from the measurement object passes through the first lens surface 410 and reaches the light emitting unit 320, distance measurement efficiency of the sensor package 300 may be lowered.

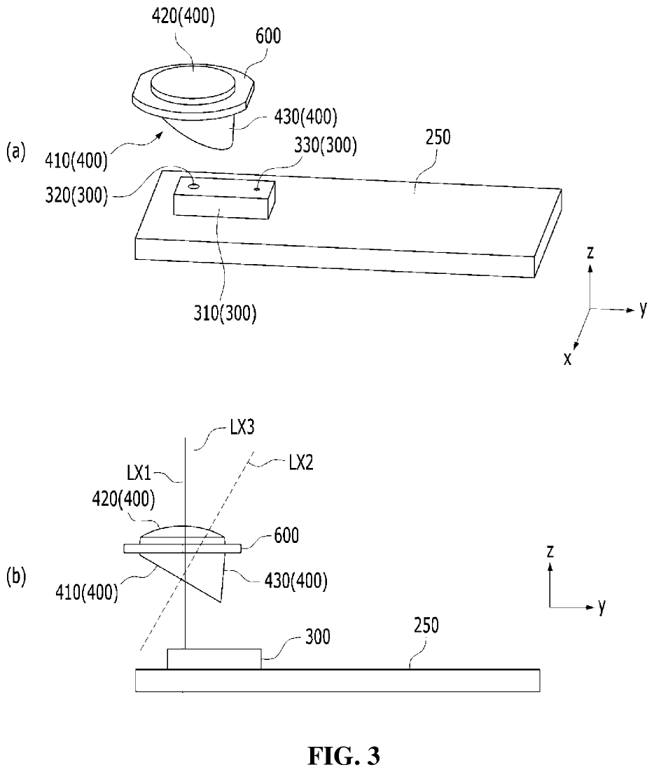

FIG. 3(a) is a view showing a substrate 250, a sensor package 300, a light emitting lens 400, and a coupling plate 600. FIG. 3(b) is a view of FIG. 3(a) seen from the front.

The sensor package 300 may be mounted on the substrate 250. The sensor package 300 may be located on the top surface of the substrate 250. The light emitting unit 320 and the light receiving unit 330 may be located on the top surface of the base 310. The light emitting unit 320 may provide light to the light emitting lens 400. The light provided from the light emitting unit 320 may travel along the optical axis of the light emitting unit 320. A first optical axis LX1 may be the optical axis of the light emitting unit 320.

The light emitting lens 400 may be located above the light emitting unit 320. The first lens surface 410 of the light emitting lens 400 may slantingly face the light emitting unit 320. The first lens surface 410 may be located under the coupling plate 600. The optical axis of the first lens surface 410 may be referred to as a second optical axis LX2. The second optical axis LX2 may be shifted from the first optical axis LX1. The second optical axis LX2 may form an angle with the first optical axis LX1. The first lens surface 410 may be inclined downward in the direction from the light emitting unit 320 toward the light receiving unit 330. The direction from the light emitting unit 320 toward the light receiving unit 330 may be parallel to the direction from the first hollow unit 220 (see FIG. 2) toward the second hollow unit 230 (see FIG. 2). The direction from the light receiving unit 330 toward the light emitting unit 320 may be parallel to the direction from the second hollow unit 230 (see FIG. 2) toward the first hollow unit 220.

The second lens surface 420 may be located above the first lens surface 410. The second lens surface 420 may be located on the coupling plate 600. The second lens surface 420 may be spaced apart from the first lens surface 410. The second lens surface 420 may be convex toward the top. The third optical axis LX3 may be the optical axis of the second lens surface 420. The third optical axis LX3 may be parallel to the first optical axis LX1. The third optical axis LX3 may form an angle with the second optical axis LX2.

The light emitting lens 400 may form multiple optical axes. For example, the first lens surface 410 of the light emitting lens 400 may form the second optical axis LX2, and the second lens surface 420 may form the third optical axis LX3. The multiple optical axes of the light emitting lens 400 may be unaligned. For example, the second optical axis LX2 may form an angle with the third optical axis LX3.

The body surface 430 may connect the first lens surface 410 and the second lens surface 420. The body surface 430 may be longer toward the bottom as it approaches the light receiving unit 330. The body surface 430 may be coupled to the coupling plate 600.

The light starting from the light emitting unit 320 and entering the first lens surface 410 may be refracted by the first lens surface 410. The light refracted by the first lens surface 410 may enter the second lens surface 420. The light entering the second lens surface 420 from the first lens surface 410 may pass through the second lens surface 420 and reach the measurement object (not shown) located outside. The light reaching the measurement object (not shown) may be reflected and reach the second lens surface 420. The light reaching the second lens surface 420 from the outside may travel toward the first lens surface 410. Since the second optical axis LX2 forms an angle with the third optical axis LX3, the light reflected from the measurement object (not shown) and directed toward the first lens surface 410 may be prevented from traveling toward the light emitting unit 320.

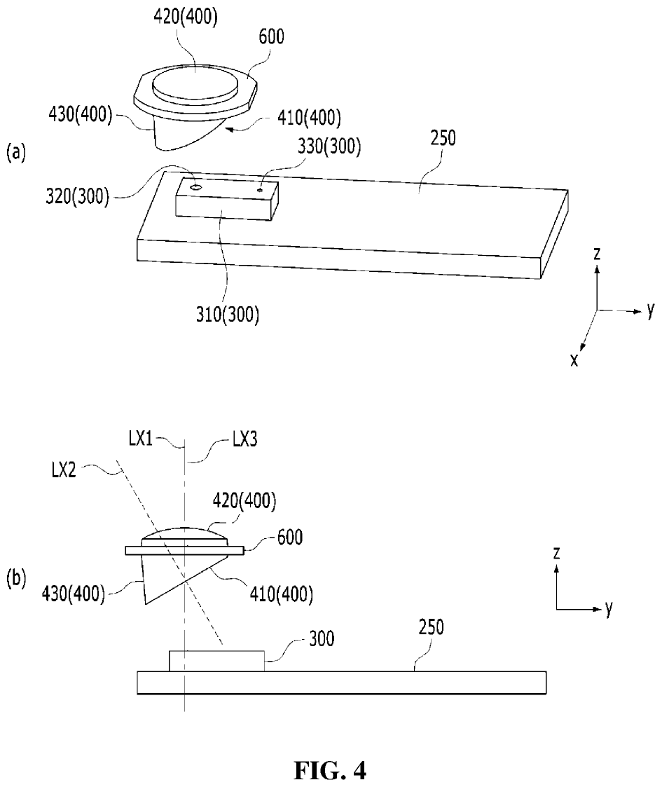

FIG. 4(a) is a view showing a substrate 250, a sensor package 300, a light emitting lens 400, and a coupling plate 600. FIG. 4(b) is a view of FIG. 4(a) seen from the front.

The light emitting lens 400 may be located above the light emitting unit 320. The first lens surface 410 of the light emitting lens 400 may slantingly face the light emitting unit 320. The first lens surface 410 may be inclined downward in the direction from the light receiving unit 330 toward the light emitting unit 320. The second optical axis LX2 may form an angle with the first optical axis LX1.

The second lens surface 420 may be convex toward the top. The third optical axis LX3 of the second lens surface 420 may be parallel to the first optical axis LX1 and form an angle with the second optical axis LX2. As the third optical axis LX3 forms an angle with the second optical axis LX2, the light reflected from the top of the light emitting lens 400 may be prevented from passing through the first lens surface 410 and traveling toward the light emitting unit 320.

The body surface 430 may be elongated upward from the first lens surface 410 and connected to the second lens surface 420. The body surface 430 may be longer downward in the direction from the light receiving unit 330 toward the light emitting unit 320.

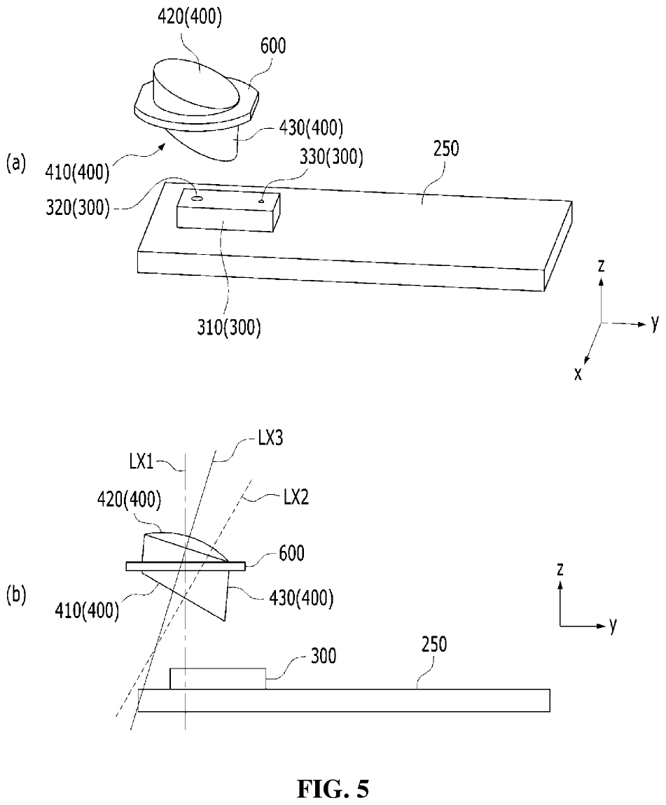

FIG. 5(a) is a view showing a substrate 250, a sensor package 300, a light emitting lens 400, and a coupling plate 600. FIG. 5(b) is a view of FIG. 5(a) seen from the front.

The light emitting lens 400 may be located above the light emitting unit 320. The first lens surface 410 of the light emitting lens 400 may slantingly face the light emitting unit 320. The first lens surface 410 may be inclined downward in the direction from the light emitting unit 320 toward the light receiving unit 330. The second optical axis LX2 may form an angle with the first optical axis LX1.

The second lens surface 420 may be inclined with respect to the sensor package 300. For example, the plane formed by the outer circumference of the second lens surface 420 may be inclined downward in the direction from the light emitting unit 320 toward the light receiving unit 330. The second lens surface 420 may be convex toward the outside. The third optical axis LX3 of the second lens surface 420 may form an angle with the first optical axis LX1 of the light emitting unit 320. The third optical axis LX3 may form an angle with the second optical axis LX2.

For example, the third optical axis LX3 may be located between the first optical axis LX1 and the second optical axis LX2. An angle (acute angle) formed by the first optical axis LX1 and the second optical axis LX2 may be referred to as a first angle. An angle (acute angle) formed by the first optical axis LX1 and the third optical axis LX3 may be referred to as a third angle. An angle (acute angle) formed by the second optical axis LX2 and the third optical axis LX3 may be referred to as a second angle. The first angle may be the sum of the second angle and the third angle.

As the third optical axis LX3 forms an angle with the first optical axis LX1 and the second optical axis LX2, respectively, the light reflected from the top of the light emitting lens 400 may be prevented from passing through the second lens surface 420 and the first lens surface 410 and traveling toward the light emitting unit 320.

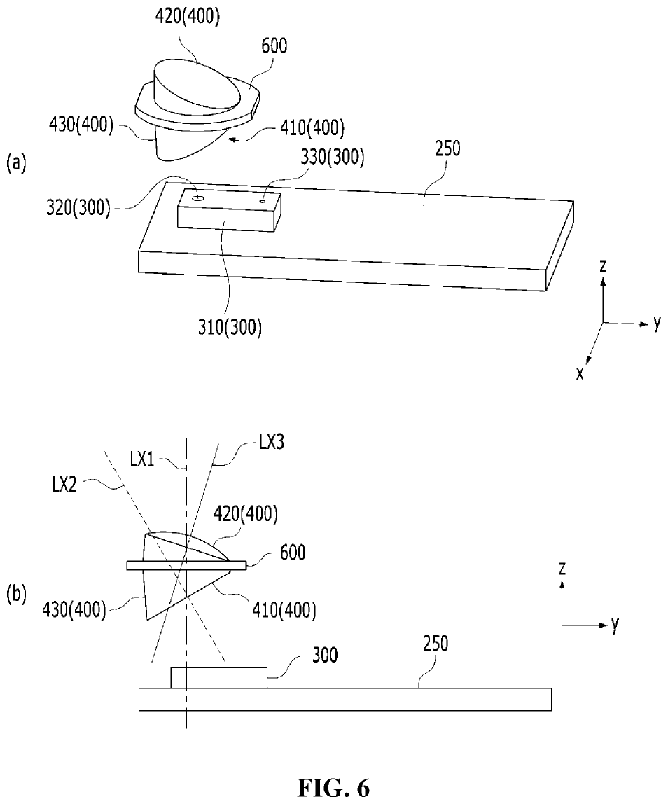

FIG. 6(a) is a view showing a substrate 250, a sensor package 300, a light emitting lens 400, and a coupling plate 600, and for convenience of explanation, it may be expressed to delete the housing 200 (refer to FIG. 2). FIG. 6(b) is a view of FIG. 6(a) seen from the front.

The light emitting lens 400 may be located above the light emitting unit 320. The first lens surface 410 of the light emitting lens 400 may slantingly face the light emitting unit 320. The first lens surface 410 may be inclined downward in the direction from the light receiving unit 330 toward the light emitting unit 320. The second optical axis LX2 may form an angle with the first optical axis LX1.

The second lens surface 420 may be inclined with respect to the sensor package 300. For example, the plane formed by the outer circumference of the second lens surface 420 may be inclined upward in the direction from the light receiving unit 330 toward the light emitting unit 320. The second lens surface 420 may be convex toward the outside.

An angle (acute angle) formed by the first optical axis LX1 and the second optical axis LX2 may be referred to as a first angle. An angle (acute angle) formed by the first optical axis LX1 and the third optical axis LX3 may be referred to as a third angle. An angle (acute angle) formed by the second optical axis LX2 and the third optical axis LX3 may be referred to as a second angle. The first optical axis LX1 may be located between the second optical axis LX2 and the third optical axis LX3. The second angle may be the sum of the first angle and the third angle.

As the second optical axis LX2 and the third optical axis LX3 form an angle with respect to the first optical axis LX1, respectively, the light reflected from the top of the light emitting lens 400 may be prevented from passing through the second lens surface 420 and the first lens surface 410 and traveling toward the light emitting unit 320.

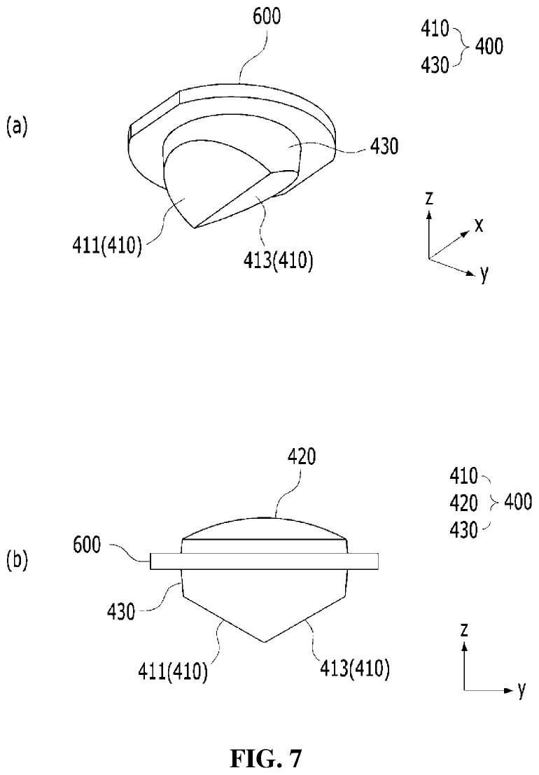

FIG. 7(a) is a view showing a light emitting lens 400 and a coupling plate 600. FIG. 7(b) is a view of the light emitting lens 400 and the coupling plate 600 of FIG. 7(a) seen from the front.

The first lens surface 410 may include a first incident surface 411 and a second incident surface 413. The first incident surface 411 may form an angle with the second incident surface 413. The first incident surface 411 and the second incident surface 413 may increase downward in the direction toward the boundary of the first incident surface 411 and the second incident surface 413.

The first incident surface 411 may be inclined downward in the direction from the light emitting unit 320 (see FIG. 2) toward the light receiving unit 330 (see FIG. 2). The second incident surface 413 may be inclined downward in the direction from the light receiving unit 330 (see FIG. 2) toward the light emitting unit 320 (see FIG. 2).

At least one among the first incident surface 411 and the second incident surface 413 may slantingly face the light emitting unit 320 (see FIG. 2). For example, the first incident surface 411 may slantingly face the light emitting unit 320 (see FIG. 2). The light generated from the light emitting unit 320 (refer to FIG. 2) may be refracted by the first incident surface 411 in the direction from the first incident surface 411 toward the second incident surface 413, and reach the second lens surface 420.

The light reaching the second lens surface 420 may pass through the second lens surface 420, and reach the measurement object (not shown) through the second lens surface 420. The light reaching the measurement object (not shown) may be reflected from the measurement object (not shown) and reach the second lens surface 420. The light reaching the second lens surface 420 may travel toward the first lens surface 410. The light traveling from the second lens surface 420 toward the first lens surface 410 may be divided into light traveling from the second lens surface 420 toward the first incident surface 411 and light traveling from the second lens surface 420 toward the second incident surface 413.

The light traveling from the second lens surface 420 toward the second incident surface 413 may be refracted by the second incident surface 413. Input of the light refracted by the second incident surface 413 into the light emitting unit 320 (see FIG. 2) may be suppressed by the geometric structure of the first lens surface 410.

The light traveling from the second lens surface 420 toward the second incident surface 413 may be totally internally reflected by the second incident surface 413. A large portion of the light totally internally reflected by the second incident surface 413 may be totally internally reflected by the first incident surface 411 and directed toward the second lens surface 420. That is, input of the light totally internally reflected by the second incident surface 413 into the light emitting unit 320 (see FIG. 2) may be suppressed by the geometric structure of the first lens surface 410.

The light traveling from the second lens surface 420 toward the first incident surface 411 may be refracted or totally internally reflected by the first incident surface 413. For example, a large portion of the light totally internally reflected by the first incident surface 411 may be totally internally reflected by the second incident surface 413 and directed toward the second lens surface 420. Accordingly, input of the light traveling from the second lens surface 420 toward the first incident surface 411 into the light emitting unit 320 (see FIG. 2) may be suppressed by the geometric structure of the first lens surface 410.

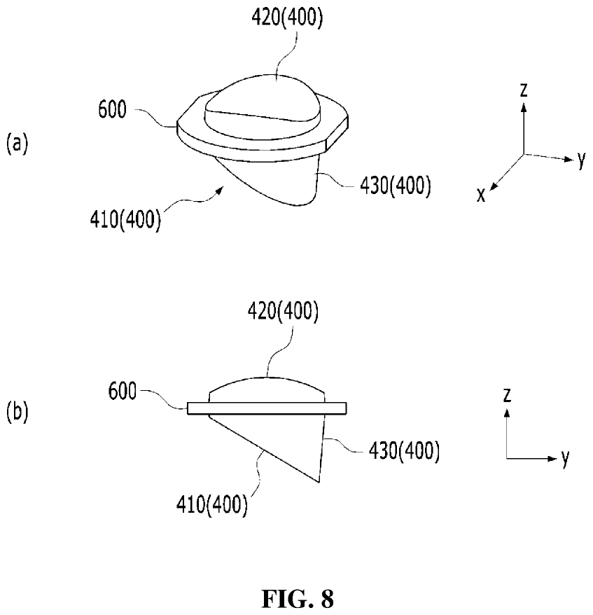

FIG. 8(a) is a view showing a light emitting lens 400 and a coupling plate 600. FIG. 8(b) is a view of the light emitting lens 400 and the coupling plate 600 of FIG. 8(a) seen from the front.

The first lens surface 410 may be inclined downward in the direction from the light emitting unit 320 (see FIG. 2) toward the light receiving unit 330 (see FIG. 2). The first lens surface 410 may have a shape elongated downward in the direction toward the positive Y axis. The positive Y-axis direction may be a direction from the light emitting unit 320 (see FIG. 2) toward the light receiving unit 330 (see FIG. 2).

The second lens surface 420 may have a shape protruding upward in the direction toward the positive Y axis. The second lens surface 420 may have a partial shape of the lateral surface of a cylinder having the X-axis direction as the length direction.

The second lens surface 420 may be inclined downward in the first direction from the most protruding portion. For example, the second lens surface 420 may be inclined downward in the positive Y-axis direction from the most protruding portion. The second lens surface 420 may be inclined downward in the negative Y-axis direction from the most protruding portion.

The second lens surface 420 may be parallel to the horizontal surface in the second direction from the most protruding portion. For example, the second lens surface 420 may be parallel to the horizontal surface in the X-axis direction (positive direction and negative direction).

The shapes of the second lens surface 420 and the first lens surface 410 may suppress the light emitted from the light emitting unit 320 (see FIG. 2), passing through the light emitting lens 400, and reflected by the measurement target (not shown) not to pass through the light emitting lens 400 and travel toward the light emitting unit 320 (see FIG. 2) again.

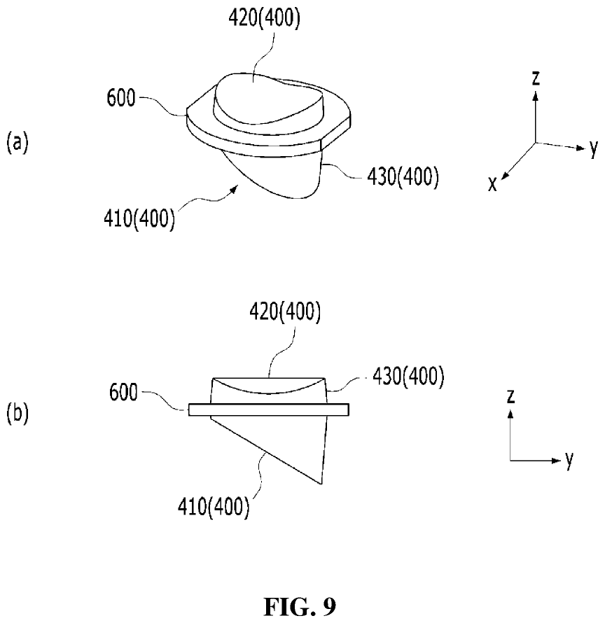

FIG. 9(a) is a view showing a light emitting lens 400 and a coupling plate 600. FIG. 9(b) is a view of the light emitting lens 400 and the coupling plate 600 of FIG. 9(a) seen from the front.

The configuration of the first lens surface 410 may be the same as that of the first lens surface 410 shown in FIG. 8.

The second lens surface 420 may have a shape protruding upward in the direction toward the positive X axis. The second lens surface 420 may have a partial shape of the lateral surface of a cylinder having the Y-axis direction as the length direction.

The second lens surface 420 may be inclined downward in the first direction from the most protruding portion. For example, the second lens surface 420 may be inclined downward in the positive X-axis direction from the most protruding portion. The second lens surface 420 may be inclined downward in the negative X-axis direction from the most protruding portion.

The second lens surface 420 may be parallel to the horizontal surface in the second direction from the most protruding portion. For example, the second lens surface 420 may be parallel to the horizontal surface toward the Y-axis direction (positive direction and negative direction).

The light emitted from the light emitting unit 320 (see FIG. 2), passing through the light emitting lens 400, and reflected by the measurement target (not shown) may be prevented from passing through the light emitting lens 400 and traveling toward the light emitting unit 320 (see FIG. 2) again due to the shapes of the second lens surface 420 and the first lens surface 410.

Referring to FIGS. 1 to 9, the lens surfaces 410 and 420 may mean at least one among the first lens surface 410 and the second lens surface 420. The shape of the lens surfaces 410 and 420 may include a flat shape and/or a curved shape. For example, the lens surfaces 410 and 420 may include a spherical surface and/or an aspherical surface. For example, the lens surfaces 410 and 420 may include a conic surface and/or an asymmetric curved surface.

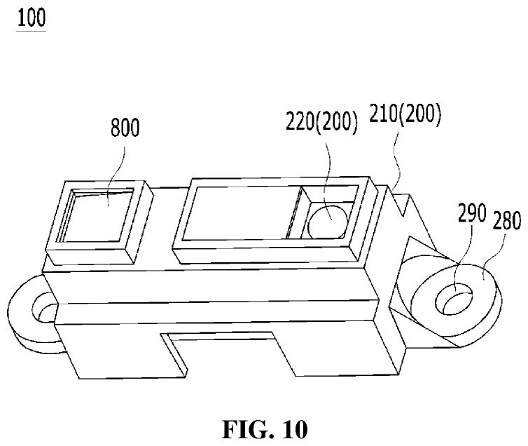

Referring to FIG. 10, a distance measurement sensor 100 according to another embodiment of the present invention may be observed. The distance measurement sensor 100 may include a housing 200. The housing 200 shown in FIG. 10 may have a structure similar to that of the housing 200 shown in FIGS. 1 and 2. For example, the housing 200 may include a housing body 210. The housing body 210 may form a skeleton of the housing 200. The housing body 210 may protect the parts installed inside the housing 200. The housing body 210 may be formed of a material such as metal and/or synthetic resin.

The housing 200 may include a first hollow unit 220. The first hollow unit 220 may be formed in the housing body 210. The first hollow unit 220 may be adjacent to one end of the housing 200. The first hollow unit 220 may be opened toward the top of the housing 200.

The housing 200 may include a second hollow unit (not shown). The second hollow unit may be formed in the housing body 210. The second hollow unit may be adjacent to the other end of the housing 200. The first hollow unit may be opened toward the top of the housing 200.

The housing 200 may include a coupling unit 280. The coupling unit 280 may be coupled to the housing body 210. The coupling unit 280 may be integrally formed with the housing body 210. A coupling hole 290 may be formed in the coupling unit 280. The coupling hole 290 may have a shape of a hole. The coupling hole 290 may be coupled to a bolt. The bolt passing through the coupling hole 290 may be coupled to an electronic device or the like.

The distance measurement sensor 100 may include a light receiving lens 800. The light receiving lens 800 may be located in the housing 200. The light receiving lens 800 may be located on the opposite side of the first hollow unit 220. For example, the light receiving lens 800 may be located in the second hollow unit of the housing 200.

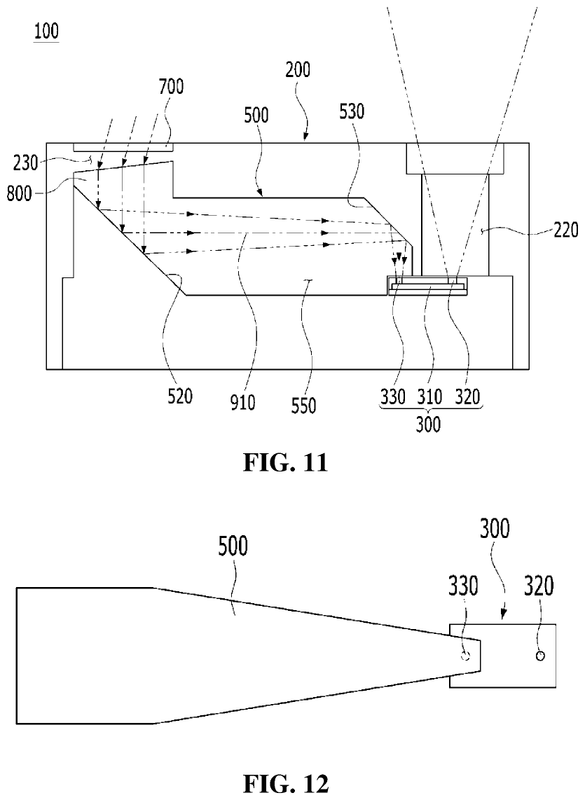

FIG. 11 is a cross-sectional view showing the distance measurement sensor 100 shown in FIG. 10. For convenience of explanation, the coupling unit 280 shown in FIG. 10 may not be shown in FIG. 11.

The housing 200 may form a first hollow unit 220. The first hollow unit 220 may be adjacent to one end of the housing 200. The housing 200 may form a second hollow unit 230. The second hollow unit 230 may be adjacent to the other end of the housing 200. The second hollow unit 230 may be opened toward the top. The second hollow unit 230 may provide a space in which the light receiving lens 800 is accommodated.

The distance measurement sensor 100 may include a light receiving panel 700. The light receiving panel 700 may be transparent. For example, the light receiving panel 700 may transmit light. The light receiving panel 700 may be coupled or attached to the housing 200. The light receiving panel 700 may be located in the second hollow unit 230. For example, the light receiving panel 700 may be located above the second hollow unit 230. The light receiving panel 700 may shield the second hollow unit 230.

The light receiving lens 800 may be coupled to or installed in the housing 200. The light receiving lens 800 may be located, for example, in the second hollow unit 230. The light receiving lens 800 may be located under the light receiving panel 700. The top surface of the light receiving lens 800 may form a slope. For example, the top surface of the light receiving lens 800 may form a slope facing upward in the direction toward the first hollow unit 220.

The distance measurement sensor 100 may include a light guide 500. The structural and/or optical properties of the light guide 500 shown in FIG. 11 may be substantially the same as the structural and/or optical properties of the light guide 500 shown in FIG. 2. For example, the light guide 500 may include a second guide surface 520 and a third guide surface 530. The second guide surface 520 may be adjacent to the light receiving lens 800. The third guide surface 530 may be adjacent to the sensor package 300. The light guide 500 may include an optical path unit 550. The optical path unit 550 may mean the inside of the light guide 500.

The light guide 500 may be located under the light receiving lens 800. For example, at least a portion of the light guide 500 may be located under the light receiving lens 800. The light guide 500 may have a shape elongated from the light receiving lens 800 toward the first hollow unit 220. The light guide 500 may be coupled to the light receiving lens 800. For example, the light guide 500 may be coupled to the bottom surface of the light receiving lens 800. The light guide 500 may be integrally formed with the light receiving lens 800.

In FIG. 11, the dash double dot line arrows may indicate optical paths. Among the optical paths, a main optical path 910 may be formed. The main optical path 910 may be a path of light, along which at least part of the light provided from the light receiving lens 800 is totally internally reflected from the second guide surface 520 and directed toward the third guide surface 530. The main optical path 910 may be a path of light, along which at least part of the light directed toward the third guide surface 530 is totally internally reflected from the third guide surface 530 and directed toward the light receiving unit 330.

The distance measurement sensor 100 may include a sensor package 300. The structure and/or the characteristics of the sensor package 300 shown in FIG. 11 may be substantially the same as the structure and/or the characteristics of the sensor package 300 shown in FIG. 2. At least a portion of the sensor package 300 may be located under the first hollow unit 220. The sensor package 300 may include a base 310. The base 310 may be coupled to or installed in the housing 200.

The sensor package 300 may include a light emitting unit 320. The light emitting unit 320 may be located on the top of the base 310. The light emitting unit 320 may be electrically connected to the base 310. The light emitting unit 320 may receive power from the base 310. The light emitting unit 320 may be located under or on the bottom of the first hollow unit 220. The light emitting unit 320 may provide light toward the first hollow unit 220. For example, the light emitting unit 320 may provide light having a wavelength of a predetermined range. For example, the light emitting unit 320 may provide infrared light. For example, the light emitting unit 320 may include an infrared LED.

The sensor package 300 may include a light receiving unit 330. The light receiving unit 330 may be disposed on the top surface of the base 310. The light receiving unit 330 may be electrically connected to the base 310. The light receiving unit 330 may face the light guide 500. The light receiving unit 330 may receive light from the light guide 500. The light receiving unit 330 may sense light.

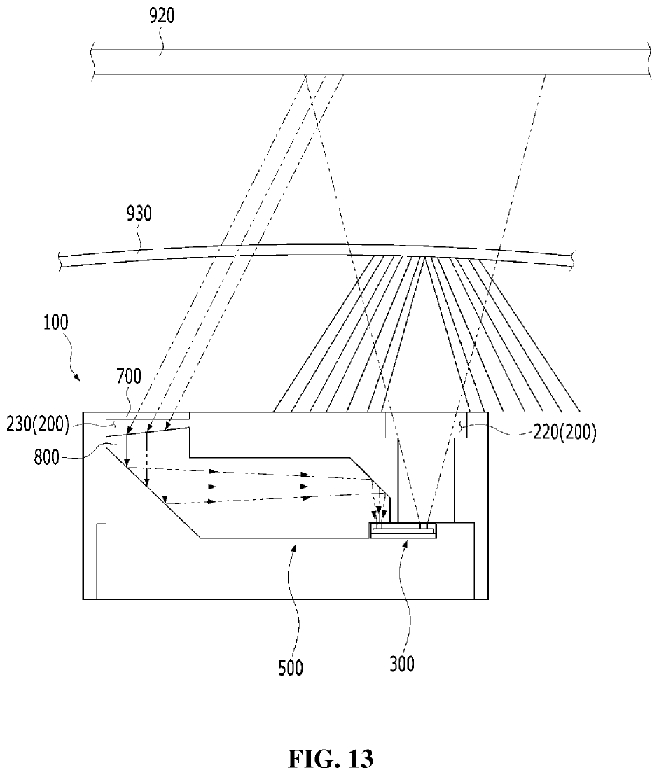

Referring to FIG. 12, the width of the light guide 500 may decrease toward the light receiving unit 330. In other words, the width of the light guide 500 may decrease from the second guide surface 520 (see FIG. 11) toward the third guide surface 530 (see FIG. 11).

The light guide 500 may receive light from the light receiving lens 800 (see FIG. 11) and provide the light to the light receiving unit 330. The size of the light receiving unit 330 may be smaller than that of the light receiving lens 800 (see FIG. 11). Accordingly, the light guide 500 having a width decreasing toward the light receiving unit 330 may transmit light to the light receiving unit 330 more efficiently. In other words, the light guide 500 having a width decreasing toward the light receiving unit 330 may collect light efficiently.

Referring to FIG. 13, the distance measurement sensor 100 may be disposed or installed in an electronic device. For example, the distance measurement sensor 100 may be disposed or installed in the robot cleaner. A see-through window 930 of the robot cleaner may be located on the distance measurement sensor 100.

The light provided from the light emitting unit 320 (see FIG. 11) of the sensor package 300 may pass through the first hollow unit 220 and reach the see-through window 930. The light provided from the light emitting unit 320 (see FIG. 11) of the sensor package 300 may be indicated as dash double dot lines in FIG. 13.

Part of the light reaching the see-through window 930 may pass through the see-through window 930. Other part of the light reaching the see-through window 930 may be reflected from the see-through window 930. The light reflected from the see-through window 930 may be indicated as solid lines in FIG. 13. When the light reflected from the see-through window 930 is provided to the light receiving panel 700, the light sensed by the light receiving unit 330 (see FIG. 11) of the sensor package 300 may include noise. That is, when the light reflected from the see-through window 930 is provided to the light receiving panel 700, malfunction of the sensor package 300 may occur. As the light receiving panel 700 is spaced apart from the first hollow unit 220 by a predetermined distance, input of the light reflected from the see-through window 930 into the light receiving panel 700 may be suppressed.

At least part of the light passing through the see-through window 930 may reach the object 920. At least part of the light reaching the object 920 may be reflected from the object 920 and reach the see-through window 930. At least part of the light reaching the see-through window 930 may pass through the see-through window 930 and reach the light receiving panel 700. At least part of the light reaching the light receiving panel 700 may pass through the light receiving panel 700 and reach the light receiving lens 800. At least part of the light reaching the light receiving lens 800 may pass through the light receiving lens 800 and proceed toward the light guide 500. At least part of the light provided to the light guide 500 may be provided to the light receiving unit 330 (see FIG. 11) of the sensor package 300.

The sensor package 300 may measure a time (hereinafter, referred to as “flight time”) of the light provided from the light emitting unit 320 (see FIG. 11), which is taken to reach the light receiving unit 330 (see FIG. 11) after being reflected from the object 920. The flight time may have a positive correlation with the distance between the distance measurement sensor 100 and the object 920. For example, the flight time may be proportional to the distance between the distance measurement sensor 100 and the object 920. The sensor package 300 may extract information on the distance between the distance measurement sensor 100 and the object 920 from the flight time.

The light receiving panel 700 and/or the light receiving lens 800 may selectively transmit light having a wavelength of a predetermined range. The light receiving panel 700 and/or the light receiving lens 800 may selectively transmit, for example, infrared light. For example, the light emitting unit 320 (see FIG. 11) of the sensor package 300 may provide infrared light. In other words, the light used by the sensor package 300 to detect the object 920 is infrared light, and light having a wavelength different from that of the infrared light may be a noise from the aspect of the light receiving unit 330 (see FIG. 11) of the sensor package 300. If the light receiving panel 700 and/or the light receiving lens 800 does not transmit light other than the infrared light, the noise provided to the light receiving unit 330 (see FIG. 11) of the sensor package 300 may be reduced.

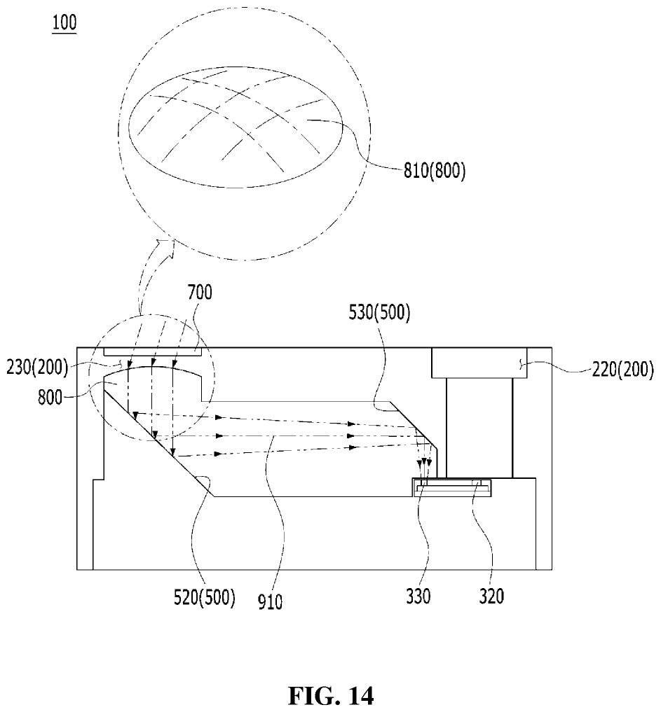

Referring to FIG. 14, the light receiving lens 800 may include a top surface 810. The top surface 810 of the light receiving lens 800 may face the light receiving panel 700. The top surface 810 of the light receiving lens 800 may be convex toward the top. The top surface 810 of the light receiving lens 800 may include a spherical surface.

The light receiving lens 800 may perform a function of a convex lens. That is, the light passing through the light receiving lens 800 may be collected. The collected light may travel inside the light guide 500 and be provided to the light receiving unit 330. The second guide surface 520 and the third guide surface 530 may be formed as a plane. In this case, the property of the light collected by the light receiving lens 800 may be preserved in the second guide surface 520 and the third guide surface 530. That is, the light passing through the light receiving lens 800 may maintain the collected property even when the light passes through the second guide surface 520 and the third guide surface 530.

Alternatively, the second guide surface 520 and the third guide surface 530 may be configured in a spherical or aspherical shape. In this case, the light receiving lens 800 may primarily collect the light transmitted from the light receiving panel 700. The second guide surface 520 may secondarily collect the light transmitted from the light receiving lens 800. The third guide surface 530 may thirdly collect light transmitted from the second guide surface 520.

In this case, the light receiving lens 800, the second guide surface 520, and the third guide surface 530 may be formed or disposed to collect the light transmitted from the light receiving panel 700 on the light receiving unit 330.

The second guide surface 520 and the third guide surface 530 like this may have various shapes in addition to the shape of the spherical or aspherical surface. In this case, the focus of the light transmitted from the light receiving panel 700 may be formed on the light receiving unit 330.

As described above, the light receiving lens 800, the second guide surface 520, and the third guide surface 530 may be formed to focus the light transmitted from the light receiving panel 700 on the light receiving unit 330.

In addition, the light receiving lens 800 of the distance measurement sensor 100 may be formed of an aspherical lens. Compared with the spherical lens, the aspherical lens may be different from the aspect of collection of light. The shapes of the second guide surface 520 and the third guide surface 530 may be diversely modified so that the focus of the light transferred from the light receiving panel 700 may be formed on the light receiving unit 330.

Table 1 shows a result of simulating the embodiments according to the present invention and comparative example.

TABLE 1

| | Comparative | First | Second |
|---|---|---|---|
| | example | embodiment | embodiment |
| 10 Cm | 22 | 37 | 27 |
| 20 Cm | 5 | 10 | 10 |
| 30 Cm | 1 | 2 | 10 |
| 40 Cm | 3 | 4 | 9 |

(Based on two millions of light radiated from light emitting unit)

Table 1 shows experiment data measuring the number of light flowing in the light receiving unit 330, when the number of light radiated from the light emitting unit 320 is two million, by using the distance measurement sensors 100 according to the first embodiment, the second embodiment, and the comparative example, respectively.

Table 1 shows the number of light guided to the light receiving unit 330 while the distance between the distance measurement sensor 100 and the object 920 (see FIG. 13) is adjusted to 10 cm, 20 cm, 30 cm, and 40 cm, respectively. The number of light may mean the number of photons.

The distance measurement sensor 100 according to the comparative example may be a distance measurement sensor 100 without having a light guide 500. The distance measurement sensor 100 according to the first embodiment is the distance measurement sensor 100 shown in FIG. 13. The distance measurement sensor 100 according to the second embodiment is the distance measurement sensor 100 shown in FIG. 14.

Referring to Table 1, the number of photons guided to the light receiving unit 330 of the distance measurement sensor 100 according to the first and second embodiments may be larger than the number of photons guided to the light receiving unit 330 of the distance measurement sensor 100 according to the comparative example. That is, the light receiving performance of the distance measurement sensor 100 according to the first and second embodiments may be superior to the light receiving performance of the distance measurement sensor 100 according to the comparative example.

In addition, when the distance from the distance measurement sensor 100 to the object 920 (refer FIG. 13) exceeds 20 cm, the light receiving performance of the distance measurement sensor 100 according to the second embodiment may be superior to the light receiving performance of the distance measurement sensor 100 according to the comparative example and the first embodiment.

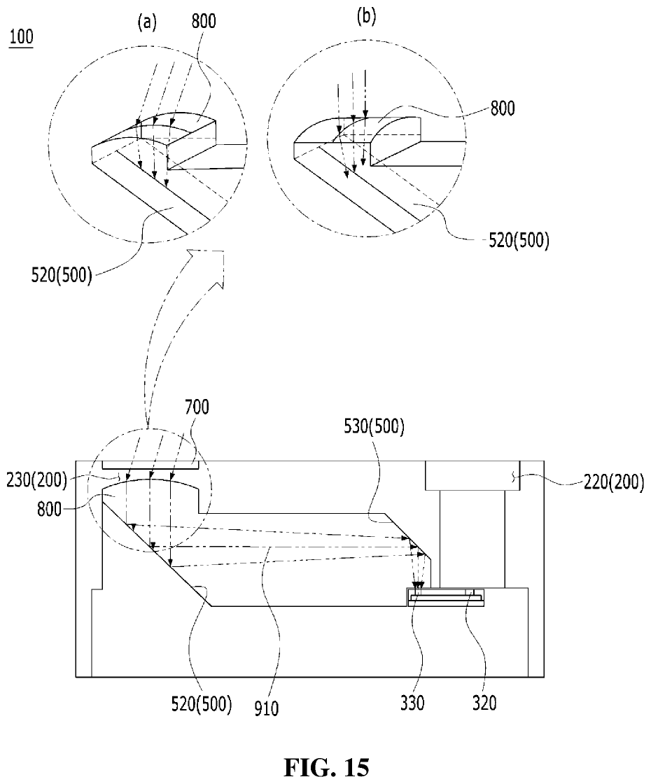

FIG. 15 is a view showing a distance measurement sensor 100 according to a third embodiment of the present invention. Referring to FIG. 15, the distance measurement sensor 100 according to the third embodiment may be different from the distance measurement sensor 100 according to the first embodiment (see FIG. 13). For example, the light receiving lens 800 of the distance measurement sensor 100 according to the third embodiment may be formed as a cylindrical lens.

The cylindrical lens is a lens using a cylindrical surface parallel to the axis of a cylinder as a refractive surface. The light receiving lens 800 may collect light entering the cylindrical surface on a straight line parallel to the axis of the cylinder. That is, the light receiving lens 800 is configured to form a focal line.

A focal line of light passing through the light receiving lens 800 may be formed in the width direction of the light guide 500 by the light receiving lens 800 of FIG. 15(a). The focal line of the light passing through the light receiving lens 800 may be formed in the length direction of the light guide 500 by the light receiving lens 800 of FIG. 15(b). Like this, the focal line formed by the light receiving lens 800 may vary according to the arrangement and/or shape of the light receiving lens 800.

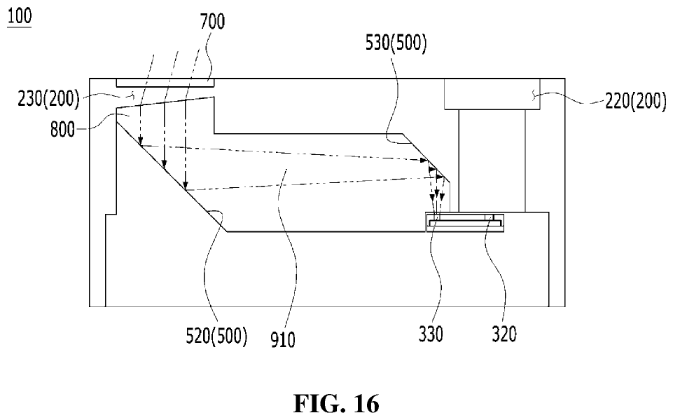

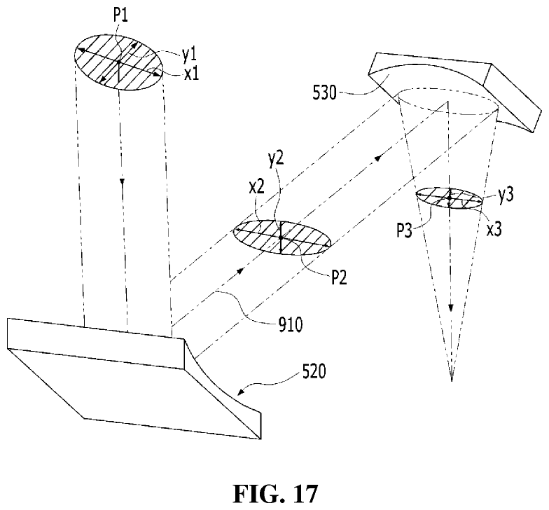

FIG. 16 is a view showing a distance measurement sensor 100 according to a fourth embodiment of the present invention. FIG. 17 is an exemplary view schematically showing the cross section of light at each point guided along a main optical path 910 in the distance measurement sensor 100 according to the fourth exemplary embodiment of the present invention.

Referring to FIGS. 16 and 17, the second guide surface 520 and the third guide surface 530 of the distance measurement sensor 100 according to the fourth embodiment may have a cylindrical shape.

Here, the light receiving lens 800 may be a light receiving lens 800 in which the top surface of the light receiving lens 800 is inclined upward in the direction toward the first hollow unit 220 as shown in in the first embodiment. The light receiving lens 800 may refract light and change the traveling direction of the light without collecting the light.

The second guide surface 520 and the third guide surface 530 may have a concave cylinder shape on the basis of the light traveling inside the light guide 500. The size of the second guide surface 520 may be different from that of the third guide surface 530. That is, when the width of the light guide 500 decreases from the second guide surface 520 toward the third guide surface 530, the size of the second guide surface 520 may be different from the size of the third guide surface 530. At this point, each focal line formed by the second guide surface 520 and the third guide surface 530 may be formed on the light receiving unit 330. The focal lines formed by the second guide surface 520 and the third guide surface 530 may be perpendicular to each other on the light receiving unit 330. Accordingly, the focus of the light successively reflected from the second guide surface 520 and the third guide surface 530 may be formed on the light receiving unit 330.

In other words, the length of the focal line formed by the second guide surface 520 may gradually decrease after passing through the third guide surface 530. Accordingly, the focus of light may be formed on the light receiving unit 330.

Changes in the shape of light moving along the main optical path 910 will be described with reference to FIG. 17. The second guide surface 520 and the third guide surface 530 shown in FIG. 17 may be shown in the shape of a reflector to conveniently explain total internal reflection.

The light traveling inside the light guide 500 may be refracted by the second guide surface 520 and the third guide surface 530. The path through which the light travels inside the light guide 500 may be located on a plane. The Y length of the cross section of the light traveling inside the light guide 500 may mean the length of a portion located on a plane in the cross section of the light. The X length of the cross section of the light traveling inside the light guide 500 may mean the length of a portion perpendicular to the Y length in the cross section of the light.

On the main optical path 910 located between the light receiving lens 800 and the second guide surface 520, the cross section of light at the first point P1 may have a first X length x1 and a first Y length y1.

On the main optical path 910 located between the second guide surface 520 and the third guide surface 530, the cross section of light at the second point P2 may have a second X length x2 and a second Y length y2. The second Y length y2 may be smaller than the first Y length y1. The first X length x1 may not be different from the second X length x2. That is, the light reflected from the second guide surface 520 may be collected along the main optical path 910 only for the Y length.

On the main optical path 910 located between the third guide surface 530 and the light receiving unit 330, the cross section of light at the third point P3 have a third X length x3 and a third Y length y3. At this point, the third X length x3 may be smaller than the second X length x2. Here, the light reflected from the third guide surface 530 may be collected along the first light path only for the X length.

The third Y length y3 may be smaller than the second Y length y2. The reason why the third Y length y3 is smaller than the second Y length y2 is that light is collected by the third guide surface 530.

The X length and the Y length of the light guided from the third guide surface 530 to the light receiving unit 330 may be reduced, and the focus of the light may be formed on the light receiving unit 330.

Referring to FIG. 16 again, the distance measurement sensor 100 may follow equations (1) and (2) shown below.

0.8×f1≤d1+d2≤1.2×f1 Equation (1)

0.8×f2≤d2≤1.2×f2 Equation (2)

f1 may mean the focal length of the second guide surface 520. f2 may mean the focal length of the third guide surface 530. d1 may mean the distance from the second guide surface 520 to the third guide surface 530. d2 may mean the distance from the third guide surface 530 to the light receiving unit 330.

The light reflected from the second guide surface 520 and the third guide surface 530 may be collected and form a focus on the light receiving unit 330. Therefore, as the amount and density of light applied to the light receiving unit 330 increase, accuracy of the distance measurement sensor 100 may be enhanced.

Preferably, the distance measurement sensor 100 may follow equations (3) and (4) shown below.

0.9×f1≤d1+d2≤1.1×f1 Equation (3)

0.9×f2≤d2≤1.1×f2 Equation (4)

Furthermore, further preferably, the distance measurement sensor 100 may follow equations (5) and (6) shown below.

f1=d1+d2 Equation (5)

f2=d2 Equation (6)

As described above, the light reflected from the second guide surface 520 and the third guide surface 530 may be collected and form a focus on the light receiving unit 330. Accordingly, the light collecting ability of the light guide 500 including the second guide surface 520 and the third guide surface 530 may be maximized, and accuracy of the distance measurement sensor 100 may be enhanced.

Table 2 shows a result of simulating the fourth embodiment according to the present invention and the comparative example.

TABLE 2

| | Comparative | Fourth |
|---|---|---|
| | example | embodiment |
| 10 Cm | 22 | 53 |
| 10 Cm | 5 | 13 |
| 20 Cm | 1 | 3 |
| 30 Cm | 3 | 8 |

(Based on two millions of light radiated from light emitting unit)

Table 2 shows experiment data measuring the number of light flowing in the light receiving unit 330, when the number of light radiated from the light emitting unit 320 is set to two million, by using the distance measurement sensors 100 according to the fourth embodiment and the comparative example, respectively.

The distance measurement sensor 100 according to the comparative example may not include a light guide 500. The distance measurement sensor 100 according to the fourth embodiment may be the distance measurement sensor 100 shown in FIG. 16.

Referring to Table 2, when the distance from the distance measurement sensor 100 to the object 920 (see FIG. 13) is 30 cm, the number of photons transferred to the light receiving unit 330 of the distance measurement sensor 100 according to the fourth embodiment may correspond to 300% of the number of photons transferred to the light receiving unit 330 of the distance measurement sensor 100 according to the comparative example.

When the distance from the distance measurement sensor 100 to the object 920 (see FIG. 13) is 40 cm, the number of photons transferred to the light receiving unit 330 of the distance measurement sensor 100 according to the fourth embodiment may correspond to 266.7% of the number of photons transferred to the light receiving unit 330 of the distance measurement sensor 100 according to the comparative example.

As described above, compared with the distance measurement sensor 100 according to the comparative example, the distance measurement sensor 100 according to the fourth embodiment may have a relatively high distance measurement accuracy although the distance between the distance measurement sensor 100 and the object 920 (see FIG. 13) is large.

Referring to FIGS. 1 to 17, the lens units 400 and 800 may mean at least one among the light emitting lens 400 and the light receiving lens 800. The lens units 400 and 800 may be adjacent to the top of the housing 200. The lens units 400 and 800 may be adjacent to one end and/or the other end of the housing 200. The surface into which light enters, among the surface of the lens units 400 and 800, may form a slope.

The description of the present invention described above is for exemplary purpose, and those skilled in the art may understand that the present invention may be easily modified in other specific forms without changing the spirit and essential features of the present invention. Therefore, it should be understood that the embodiments described above are illustrative and not restrictive in all respects. For example, each constitutional element described as an individual form may be embodied to be distributed, and in the same manner, constitutional elements described as being distributed may also be embodied in an aggregated form.

The scope of the present invention is defined by the accompanying claims, and the meaning and scope of the claims and all changes and modifications derived from equivalent concepts thereof should be interpreted as being included in the scope of the present invention.

1. A distance measurement sensor comprising:
a housing including a first hollow unit formed to be opened toward a top at one end, and a second hollow unit formed to be opened toward the top at the other end;
a sensor package disposed in the housing and located under the first hollow unit;
a light guide disposed in the housing and located between the second hollow unit and the sensor package to transfer light entering the second hollow unit to the sensor package; and
a lens unit located in at least one among the first hollow unit and the second hollow unit, wherein
the sensor package includes:
a light emitting unit for providing light toward the first hollow unit; and
a light receiving unit spaced apart from the light emitting unit and located between the light emitting unit and the second hollow unit to receive light from the light guide, and
the lens unit includes at least one among
a light emitting lens located in the first hollow unit above the light emitting unit to slantingly face the light emitting unit; and
a light receiving lens located in the second hollow unit above the light guide to slantingly face a top of the housing.

2. The sensor according to claim 1, wherein the light emitting lens includes:
a first lens surface slantingly facing the light emitting unit;
a second lens surface spaced apart from the first lens surface to form a top surface of the light emitting lens, and having a shape convex toward the top; and
a body surface elongated from the first lens surface to be connected to the second lens surface.

3. The sensor according to claim 2, wherein the first lens surface is inclined downward in a direction from the first hollow unit toward the second hollow unit.

4. The sensor according to claim 3, wherein the second lens surface is inclined upward in a direction from the second hollow unit toward the first hollow unit.

5. The sensor according to claim 2, wherein the first lens surface is inclined downward in a direction from the second hollow unit toward the first hollow unit.

6. The sensor according to claim 2, wherein the first lens surface includes:
a first incident surface; and
a second incident surface bent and elongated from first incident surface, wherein
the first incident surface and the second incident surface are inclined downward in a direction toward a boundary of the first incident surface and the second incident surface.

7. The sensor according to claim 2, wherein the second lens surface is inclined downward in a first direction from a most protruding portion, and is parallel to a horizontal surface in a second direction.

8. The sensor according to claim 7, wherein the first direction is parallel to a direction from the first hollow unit toward the second hollow unit, and the second direction is perpendicular to the first direction.

9. The sensor according to claim 7, wherein the second direction is parallel to a direction from the first hollow unit toward the second hollow unit, and the first direction is perpendicular to the second direction.

10. The sensor according to claim 2, wherein the light emitting unit forms a first optical axis as an optical axis, the first lens surface forms a second optical axis as an optical axis, the second lens surface forms a third optical axis as an optical axis, and the second optical axis forms an angle with the first optical axis.

11. The sensor according to claim 10, wherein the first optical axis and the second optical axis form a first angle, the second optical axis and the third optical axis form a second angle, the third optical axis and the first optical axis form a third angle, and the first angle is a sum of the second angle and the third angle.

12. The sensor according to claim 10, wherein the first optical axis and the second optical axis form a first angle, the second optical axis and the third optical axis form a second angle, the third optical axis and the first optical axis form a third angle, and the second angle is a sum of the first angle and the third angle.

13. The sensor according to claim 1, wherein the light guide includes:
a first guide surface, at least a portion of which is located in the second hollow unit, for receiving light entering the second hollow unit from outside;
a second guide surface bent downward from the first guide surface and elongated toward the first hollow unit, and having a shape inclined with respect to the first guide surface;
a third guide surface located on an opposite side of the second guide surface above the light receiving unit, and having a shape inclined with respect to the first guide surface; and
a fourth guide surface bent from the third guide surface and elongated toward the second hollow unit to face the light receiving unit.

14. The sensor according to claim 13, wherein the light guide includes at least one material among polycarbonate (PC), polymethylmethacrylate (PMMA) and glass, and the second guide surface totally internally reflects at least part of light passing through the first guide surface and entering the second guide surface toward the third guide surface.

15. The sensor according to claim 13, wherein the third guide surface totally internally reflects at least part of light traveling from the second guide surface toward the third guide surface toward the fourth guide surface.

16. The sensor according to claim 13, wherein at least one among the second guide surface and the third guide surface includes a curved surface of a shape convex toward outside.

17. The sensor according to claim 1, wherein the second hollow unit is located below the top of the housing.

18. The sensor according to claim 1, wherein a top surface of the light receiving lens is inclined upward in a direction toward the second hollow unit.

19. The sensor according to claim 13, wherein the light guide has a width decreasing from the second guide surface toward the third guide surface.

20. The sensor according to claim 18, wherein the light receiving lens is coupled to the light guide.
